(19) United States
(12) Patent Application Publication
(10) Pub. No.: US 2005/0274835 A1
(43) Pub. Date: Dec. 15, 2005

(54) Grinder for pepper mill

(76) Inventor: Hsien-Yang Huang, Taipei (TW)

Correspondence Address: TROXELL LAW OFFICE PLLC, 5205 LEESBURG PIKE, SUITE 1404, FALLS CHURCH, VA, 22041, US

(21) Appl. No.: 10/863,215

(22) Filed: Jun. 9, 2004

(51) Int. Cl. A47J 42/00

(52) U.S. Cl. 241/169.1

(57) ABSTRACT

A grinder for pepper mill includes a hollow main body having alternately arranged recessed and protruded portions provided on an inner wall surface thereof, and a grinding core rotatably located in the main body. The grinding core is provided at a lower part with multiple slots and at an upper part with a stirrer consisting of multiple spaced arms. The grinding core can be turned either counterclockwise or clockwise, so that peppercorns trapped between free ends of the spaced arms of the stirrer and corners of the recessed portions on the main body are crushed before being ground into fine granules by teeth at a bottom of the main body and the slots on the lower part of the grinding core. Since the pepper mill can be operated to grind peppercorns in two directions, it is more convenient for use.

### FIELD OF THE INVENTION

The present invention relates to a grinder for pepper mill, and more particularly to a grinder for pepper mill that enables convenient grinding of peppercorns in the pepper mill either clockwise or counterclockwise, so that a user, either a left-hander or a right-hander, may operate the pepper mill more conveniently.

### BACKGROUND OF THE INVENTION

FIGS. 1 and 2 shows a conventional grinder for most commercially available pepper mills. As shown, the grinder mainly includes a grinding core 1 seated in a main body 2. Raised spiral ribs 11 formed on an outer surface of the grinding core 1 and teeth 21 provided on an inner wall surface of the main body 2 cooperate with one another to crush and grind peppercorns 3 in the pepper mill into fine granules. Although the above-structured grinder may successfully grind the peppercorns 3 into fine granules, the raised spiral ribs 11 on the outer surface of the grinding core 1 limits the pepper mill to be operated in only one direction to grind the peppercorns 3. For a user who is a left-hander, it is inconvenient to operate or turn the pepper mill because the latter is typically designed for a right-hander.

It is therefore tried by the inventor to develop a grinder for pepper mill that allows grinding of peppercorns in the pepper mill either counterclockwise or clockwise, so that the pepper mill may be conveniently operated by both the left-hander and the right-hander.

### SUMMARY OF THE INVENTION

A primary object of the present invention is to provide an improved grinder for pepper mill that enables convenient grinding of peppercorns in the pepper mill by turning a shaft of the pepper mill either clockwise or counterclockwise.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view showing a pepper mill having a conventional grinder mounted therein;

FIG. 2 is a cross sectional view showing the grinder for the pepper mill of FIG. 1;

FIG. 3 is an exploded perspective view of a grinder for pepper mill according to the present invention;

FIG. 4 is similar to FIG. 3 with an upper part of the grinder cut away to show an internal structure thereof;

FIG. 5 is an assembled view of FIG. 4;

FIG. 6 is a sectioned top view of the grinder for pepper mill according to the present invention;

FIG. 7 is similar to FIG. 6 but shows the grinder for pepper mill according to the present invention is turned counterclockwise to crush and grind peppercorns;

FIG. 8 is a perspective view of FIG. 7;

FIG. 9 is similar to FIG. 7 but shows the grinder for pepper mill according to the present invention is turned clockwise to crush and grind peppercorns;

FIG. 10 is a perspective view of FIG. 9; and

FIG. 11 is a perspective view of a pepper mill with the grinder of the present invention assembled thereto.

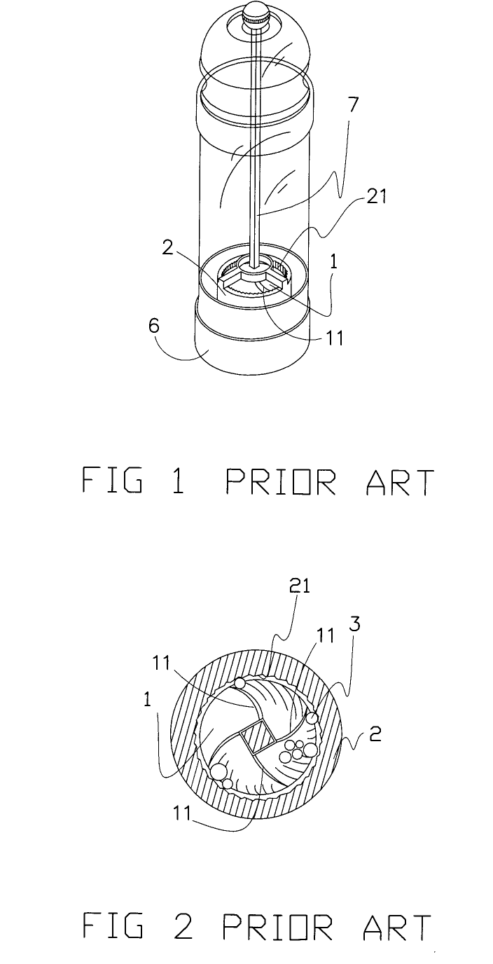

### DETAILED DESCRIPTION OF THE PREFERRED EMBODIMENTS

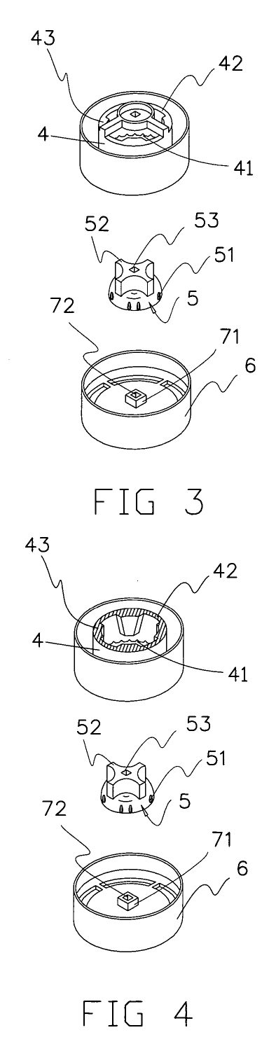

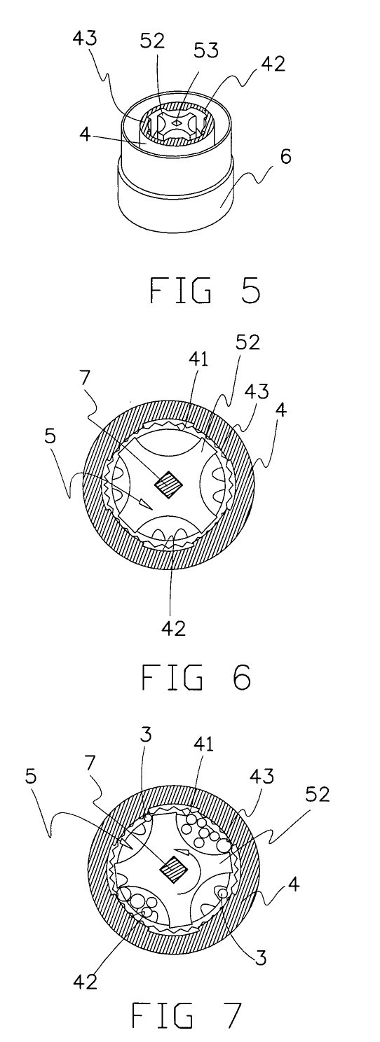

Please refer to FIG. 3 that is an exploded perspective view of a grinder for pepper mill according to the present invention. As shown, the grinder for pepper mill mainly includes a main body 4, a grinding core 5, and a base 6. As can be most clearly seen from FIGS. 4 and 5, which are exploded and assembled perspective views, respectively, of the grinder for pepper mill of the present invention with an upper part of the main body 4 being cut away to show an internal structure of the main body 4, the main body 4 of the grinder defines an internal hollow space to receive the grinding core 5 therein, and is provided at a lower part with a plurality of teeth 41, and on an inner wall surface of the hollow space with properly sized and alternately arranged radially recessed portions 42 and radially protruded portions 43.

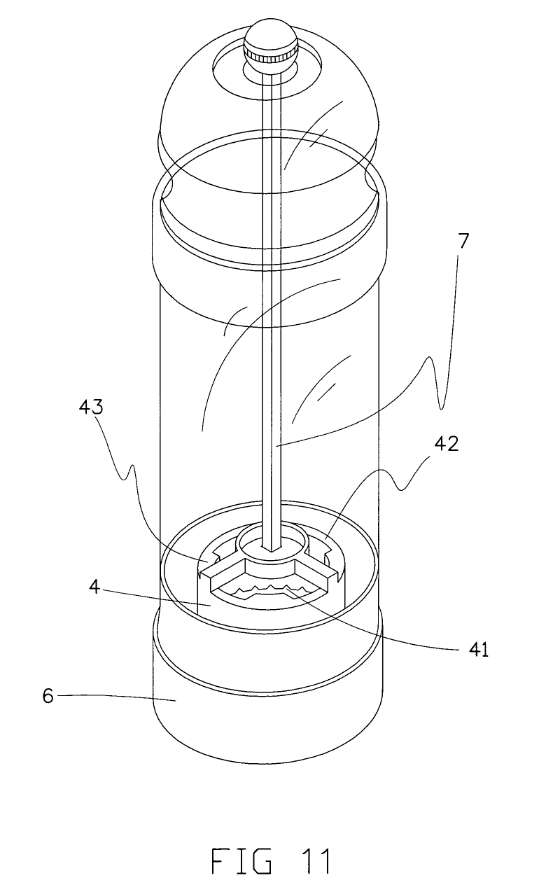

The grinding core 5 is positioned in a central area of the hollow space of the main body 4, and has a substantially flat-bottomed semispherical lower part with a plurality of suitably sized slots 51 sequentially spaced along a curved outer surface of the lower part near the flat bottom, and an upper part consisting of multiple spaced arms 52 to serve as a stirrer. The stirrer is provided with a central through hole 53 vertically extended from a top surface of the stirrer to the bottom of the semispherical lower part of the grinding core 5. A shaft 7 (see FIG. 11) is downward inserted into the through hole 53 to locate a lower end in a hole 72 on a block 71 provided at a center of the base 6, so that the shaft 7 is connected to the grinding core 5 in a tight fit relation.

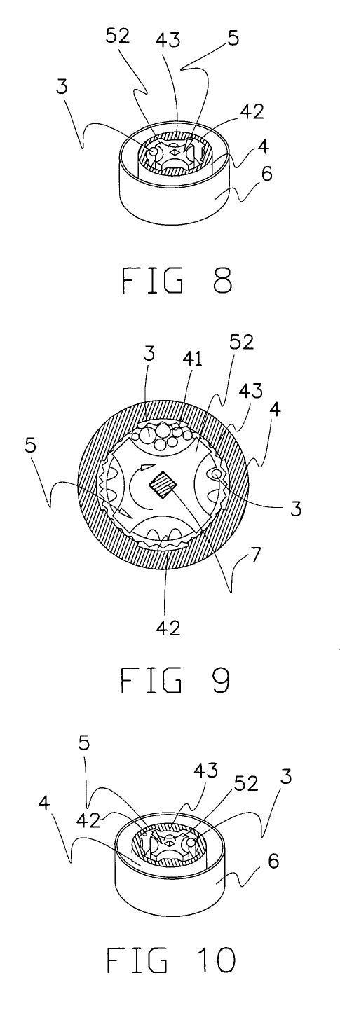

A user may rotate the shaft 7 to drive the grinding core 5 to turn either counterclockwise or clockwise. Since free ends of the multiple spaced arms 52 at the upper part of the grinding core 5 are located very close to the radially protruded portions 43 on the inner wall surface of the main body 4, as shown in FIG. 6, the manual rotation of the grinding core 5 counterclockwise (see FIGS. 7 and 8) or clockwise (see FIGS. 9 and 10) via the shaft 7 would cause one of two corners at the free end of each arm 52 that first gets into contact with an angled corner of the protruded portion 43 in the rotating direction of the grinding core 5 to crush peppercorns 3 trapped between the arms 52 and the protruded portions 43. The crushed peppercorns 3 fall to the lower part of the main body 4 and are finally ground into fine granules by the teeth 41 at the lower part of the main body 4 and the slots 51 on the semispherical lower part of the grinding core 5.

1. A grinder for pepper mill, comprising a main body and a grinding core; said main body defining an internal hollow space for receiving said grinding core therein, and being provided at a lower part with a plurality of teeth and on an inner wall surface of said hollow space with properly sized and alternately arranged radially recessed portions and radially protruded portions; and said grinding core being rotatably located at a central area of said main body and including a substantially flat-bottomed semispherical lower part and an upper part consisting of multiple spaced arms to serve as a stirrer.

2. The grinder for pepper mill as claimed in claim 1, wherein said multiple spaced arms of said upper part of said grinding core have free ends located very close to said radially protruded portions on the inner wall surface of said main body.

3. The grinder for pepper mill as claimed in claim 1, wherein said semispherical lower part of said grinding core is sequentially provided along a curved outer surface near the flat bottom with a plurality of slots.

4. The grinder for pepper mill as claimed in claim 1, wherein said grinding core is provided with a central through hole vertically extended from a top surface of said upper stirrer to the flat bottom of said semispherical lower part.
